(19) United States
(12) Patent Application Publication
(10) Pub. No.: US 2013/0293700 A1
(43) Pub. Date: Nov. 7, 2013

(54) METHOD AND APPARATUS OF MEASURING DEPTH OF OBJECT BY STRUCTURED LIGHT

(71) Applicants: LENOVO (BEIJING) LIMITED, Beijing (CN); BEIJING LENOVO SOFTWARE LTD., Beijing (CN)

(72) Inventor: Guang Yang, Beijing (CN)

(21) Appl. No.: 13/793,368

(22) Filed: Mar. 11, 2013

(30) Foreign Application Priority Data
Mar. 19, 2012 (CN) 201210073308.X

(51) Int. Cl. G01B 11/22

(52) U.S. Cl. CPC G01B 11/22
USPC 348/135

(57) ABSTRACT

A method and an apparatus of measuring a depth of an objection by structured light are disclosed. The method may comprise: projecting structured light from a light source to the object through a structured light mask; capturing a first projection image from the structured light reflected by the object, and deriving a first depth value at a first positional point from the first projection image; moving the structured light mask within a prescribed range to project further structured light to the object; capturing a second projection image from the further structured light reflected by the object, and deriving a second depth value at a second positional point from the second projection image; and acquiring a plurality of the second depth values, and performing calculation on the first depth value and the respective second depth values in accordance with a predetermined rule to derive a resultant depth value.

### CROSS-REFERENCE TO RELATED APPLICATION(S)

This Application claims priority to Chinese Patent Application No. 201210073308.X, filed on Mar. 19, 2012, the contents of which is incorporated by reference in its entirety.

### TECHNICAL FIELD

The present disclosure relates to the optical measuring field, and particularly, to a method and an apparatus of measuring a depth of an object by structured light.

### BACKGROUND

Conventional methods for measuring geometries of objects are two-dimensional ones, and thus will lose depth information of the objects. However, with the rapid development of technologies and industries, many applications desire fast and accurate measurements on geometries of three-dimensional (3D) objects.

The structured light method is often used for measuring the geometries of the 3D objects quickly and accurately because it is simple in calculation, compact, cost-efficient, and easy for installation and maintenance.

The fundamental principle of the structured light method consists in that geometrical information of an object can be extracted by means of geometrical information in illumination. For a flat surface area without apparent changes in grey level, texture and shape, the structured light method can achieve obvious light stripes, which facilitate image analyzing and processing. The structured light method is simple in calculation while relatively high in precision, and thus finds a wide range of applications in actual vision measurement systems. Measurement in accordance with the structured light method generally comprises two steps. A first step comprises projecting controllable laser light from a projector light source to a surface of an object to form a feature point, and then extracting a surface image. A second step comprises interpreting a projection pattern from geometrical characteristics of the projection image on the object surface. A distance between the feature point and a main point on a camera lens, that is, depth information of the feature point, can be derived by trigonometry. 3D coordinates of the feature point in the world coordinate system can be calculated by marking special orientations and positional parameters of the light source and the camera in the world coordinate system.

However, in measurement of the object depth in accordance with the prior art structured light method, it is found that the measurement precision is affected by the hashing degree of the point array or stripes or by the magnitude of encoding of the point array or stripes. Further, the distance between the stripes cannot be infinitesimal.

### SUMMARY

According to embodiments of the present disclosure, there are provided a method and an apparatus of measuring a depth of an object by structured light, by which it is possible to enhance the measurement precision and also enable short distance use.

According to an aspect of the present disclosure, there is provided a method of measuring a depth of an object by structured light, comprising: projecting structured light from a light source to the object through a structured light mask; capturing a first projection image from the structured light reflected by the object, and deriving a first depth value at a first positional point from the first projection image; moving the structured light mask within a prescribed range to project further structured light to the object; capturing a second projection image from the further structured light reflected by the object, and deriving a second depth value at a second positional point from the second projection image; and repeatedly performing the operations of moving the structured light mask and deriving the second depth value to acquire a plurality of the second depth values, and performing calculation on the first depth value and the respective second depth values in accordance with a predetermined rule to derive a resultant depth value.

According to a further aspect of the present disclosure, there is provided an apparatus of measuring a depth of an object by structured light, comprising: a structured light mask; a driving mechanism configured to drive the structured light mask to move; a light source configured to project structured light to the object through the structured light mask; a capturing unit configured to capture a first projection image from the structured light reflected by the object, and capture a plurality of second projection images from further structured light which is caused by movements of the structured light mask and then reflected by the object; and a calculation unit configured to derive a first depth value at a first positional point from the first projection image, derive second depth values at corresponding second positional points from the respective second projection images, and perform calculation on the first depth value and the respective second depth values to derive a resultant depth value.

With the method and apparatus according to embodiments of the present disclosure, the first depth value is derived from the first projection image, and then the structured light mask can be moved to capture a plurality of the second projection images and thus derive a plurality of the second depth values. The plurality of the second depth values and the first depth value can be processed in accordance with the predetermined rule to derive the resultant depth value. As a result, it is possible to enhance the measurement precision and also enable short distance use.

### BRIEF DESCRIPTION OF THE DRAWINGS

The technology will become apparent for those skilled in the art from the following descriptions with reference to attached drawings. It is to be understood that those drawings only illustrates some embodiments of the present disclosure, but are not intended to limit the present disclosure. Those skilled in the art can conceive other embodiments than those described in the specification in accordance with the teaching herein.

FIG. 1 is a flowchart showing a method of measuring a depth of an object by structured light according to an embodiment of the present disclosure.

FIG. 2 is a schematic diagram showing an apparatus of measuring a depth of an object by structured light according to a further embodiment of the present disclosure.

FIG. 3 is a schematic diagram showing a system of measuring a depth of an object by structured light according to a further embodiment of the present disclosure.

### DETAILED DESCRIPTION

Hereinafter, embodiments of the present disclosure will be described in detail with reference to the attached drawings. It is to be understood that those embodiments are provided for illustrating, instead of limiting, the present disclosure. Those skilled in the art can conceive other embodiments than those described in the specification in accordance with the teaching herein, which shall fall into the scope of the present disclosure.

In accordance with an embodiment of the present disclosure, there is provided a method of measuring a depth of an object by structured light.

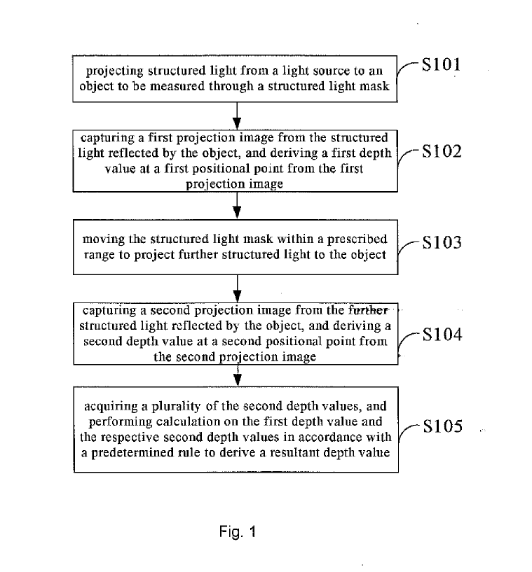

As shown in FIG. 1, the method may comprise projecting structured light from a light source to the object through a structured light mask (S101).

For example, the light source may comprise a light source for a projector, a laser light source, and the like. The present disclosure is not limited thereto.

The structured light mask can be one that is used for measuring the object depth in accordance with the structured light method. The light from the light source passes through the mask to achieve measurement of the object depth.

For example, the structured light mask may comprise at least two slits, or even more slits, such as, 8 slits, 4 slits, and so on. The present disclosure is not limited thereto. The light from the light source can be separated into multiple projection light beams through the slits provided on the structured light mask, and then the projection light beams can be projected onto the object.

The method may further comprise capturing a first projection image from the structured light reflected by the object, and deriving a first depth value at a first positional point from the first projection image (S102).

The capturing of the first projection image can be achieved by a camera, or other capturing devices. The present disclosure is not limited thereto.

For example, the first projection image can be one that is imaged by the camera by receiving the structured light reflected by the object.

Here, the so-called “first positional point” is a positional potion corresponding to the first depth value derived by processing the captured first projection image.

The method may further comprise moving the structured light mask within a prescribed range to project further structured light to the object (S103).

For example, the structured light mask may be rotated at a preset time interval and at a preset angle clockwise or counterclockwise within the prescribed range.

The prescribed range can be set as small as the measurement precision to be achieved. However, the present disclosure is not limited thereto. For example, the prescribed range can be any suitable range, provided that it will not result in excessive measurement errors.

It is to be noted that the movement of the structured light mask can be triggered at the preset time interval, or non-periodically, so long as that a second depth value at a second positional point derived from a second projection image captured by the camera comprises different values. The present disclosure is not limited thereto.

In accordance with an example, the movement of the structured light mask within the prescribed range can be driven by a motor.

Specifically, the motor can be provided at the structured light mask, and may have a program installed therein for controlling the motor. The control program can be configured to control the motor to drive the structured light mask to rotate at the preset time interval and at the preset angle clockwise or counterclockwise, or to move at a specific time point.

Further, the motor may be configured to drive the structure light mask at a certain frequency to move within the prescribed range. The frequency at which the motor drives the structured light mask may be substantially identical with a frequency at which the second projection image is captured from the structured light reflected by the object. That is, the movement of the structured light mask and the capturing of the second projection image can be carried out synchronously. In this way, it is possible to avoid capturing of a second projection image when the structured light mask is moved back to a position at which a corresponding projection image has already been captured, and thus reduce repeated operations.

For example, the motor can be configured to drive the structured light mask to move in a simple harmonic vibration.

The simple harmonic vibration is a form of vibration. For a particle in a rectilinear vibration, if its equilibrium position is assumed as being an origin and its movement track is assumed as being in an “x” axis, then a displacement, x, of the particle from the equilibrium position varies with the time t in a cosine or sine function as follows: x=A cos (2*π*t/T+φ). Such a rectilinear vibration is so-called “simple harmonic vibration.” Here, “A” indicates an absolute value of a maximal displacement of the particle from the equilibrium position (x=0) and is called “amplitude,” “T” indicates a period of the simple harmonic vibration, and “2*π*t/T+φ” indicates a phase angle or phase of the simple harmonic vibration.

In the case where the motor drives the structured light mask to move in the simple harmonic vibration, assume that the first projection image is captured when the structured light mask is at the equilibrium position of the simple harmonic vibration, that is, at (−Kπ, +Kπ) points of the cosine or sine function. In this case, the capturing frequency at which the second projection image is captured can be set as odd times a half wavelength, that is, Kπ/2, where K is an odd number instead of an even number, such as 1, 3, 5, and the like.

Optionally, when the motor moves the structured light mask in the simple harmonic vibration, the measurement is not performed if the simple harmonic vibration is at integer times the wavelength. As a result, the measurement is performed at non-equilibrium positions of the simple harmonic vibration.

Further, the moving frequency of the structured light mask may be set to be substantially identical with the capturing frequency of the second projection image, to reduce repeated capture operations of the second projection image.

Optionally, when the motor drives the structured light mask to move in the cosine or sine function, the measurement can also follow the principle of the simple harmonic vibration. Detailed descriptions thereof are omitted here.

Further, the motor may drive the structured light mask to move within the prescribed range.

For example, the motor can be configured to drive the structured light mask to rotate clockwise at an angle or rotate counterclockwise at an angle with a center point of the structured light mask as a rotation center. In this case, the time interval at which the capturing is carried out can be set as a time period during which the structured light mask is rotated over the angle. That is, the frequency at which the capturing occurs is kept the same as the frequency at which the rotating occurs.

It is to be noted that the structured light mask can be moved within the prescribed range in any suitable movement forms and the present disclosure is not limited thereto.

Alternatively, the movement of the structured light mask within the prescribed range can be driven by ultrasonic waves.

The ultrasonic waves are sound waves with a frequency greater than 20000 Hertz. The ultrasonic waves have good directionality and penetrability, tend to have concentrated sound energy, and can travel a long distance in the water, and thus are applicable to distance measuring, speed measuring, cleaning, welding, stone breaking, and the like. The ultrasonic waves are so named because the lower limit of their frequency is beyond the human's audible level. In the present disclosure, the relatively concentrated sound energy of the ultrasonic waves is utilized to actuate small movements of the structured light mask.

Specifically, the movement of the structured light mask can be achieved by radiating the ultrasonic waves onto one same position of the structured light mask for a period.

It is to be noted that the ultrasonic waves can drive the structured light mask to move within the prescribed range in a cosine or sine function, or alternatively in a simple harmonic vibration. In this case, the measurement principle described above in conjunction with the embodiment where the motor drives the structured light mask also applies. Detailed descriptions thereof are omitted here.

Alternatively, the movement of the structured light mask within the prescribed range can be driven by a magnetic material.

Specifically, the magnetic material may be arranged on opposite sides of the structured light mask to drive the structured light mask to move within the prescribed range.

It is to be noted that the magnetic material can drive the structured light mask to move within the prescribed range in a cosine or sine function, or alternatively in a simple harmonic vibration. In this case, the measurement principle described above in conjunction with the embodiment where the motor drives the structured light mask also applies. Detailed descriptions thereof are omitted here.

Here, the movement of the structured light mask within the prescribed range can be achieved by any other suitable means. Those described above are provided for illustrating the driving means of the structured light mask, but are not intended to limit the present disclosure.

The method may further comprise capturing a second projection image from the further structured light reflected by the object, and deriving a second depth value at a second positional point from the second projection image (S104).

The capturing of the second projection image can be achieved by a camera, or other capturing devices. The present disclosure is not limited thereto.

The capturing is carried out after S103. That is, the capturing of the second projection image by the camera occurs after the movement of the structured light mask. As a result, the image is captured from the further structured light which is caused by the movement of the structured light mask and then is reflected by the object. The second depth value at the second positional point can be derived by performing calculation on the second projection image.

The method may further comprise acquiring a plurality of the second depth values, and performing calculation on the first depth value and the respective second depth values in accordance with a predetermined rule to derive a resultant depth value (S105).

Optionally, operations of S103 and S104 may be repeated for at least one more time, to derive at least one more second depth value corresponding to at least one more second positional point. Then, the respective second depth values and the first depth value can be subjected to averaging process to derive the resultant depth value.

Preferably, operations of S103 and S104 may be repeated for at least one more time, to derive at least one more second depth value corresponding to at least one more second positional point. Then, each of the second depth values and the first depth value can be subjected to averaging process respectively, to derive a resultant depth value at a midpoint between the second positional point corresponding to this second depth value and the first positional point.

Alternatively, the second depth value and the first depth value are subjected to averaging process, to derive a depth value at a midpoint between the second positional point and the first positional point. Then, operations of S103 and S104 and also averaging operation of the second depth value and the first depth value may be repeated, to derive depth values at midpoints between the respective second positional points and the first positional point.

Further, averaging process can be performed with respect to every two of the second positional points in the captured second projection images, to derive depth values at midpoints therebetween.

It is to be noted that the predetermined calculation rule is not limited to the averaging process. Any other suitable process can apply, so long as it can derive more depth points. The present disclosure is not limited thereto.

With the method according to the embodiment of the present disclosure, the first depth value is derived from the first projection image, and then a plurality of the second depth values can be derived from a plurality of the second projection images due to the movement of the structured light mask. The plurality of the second depth values and the first depth value can be processed in accordance with the predetermined rule to derive the resultant depth values. As a result, it is possible to enhance the measurement precision and also enable short distance use.

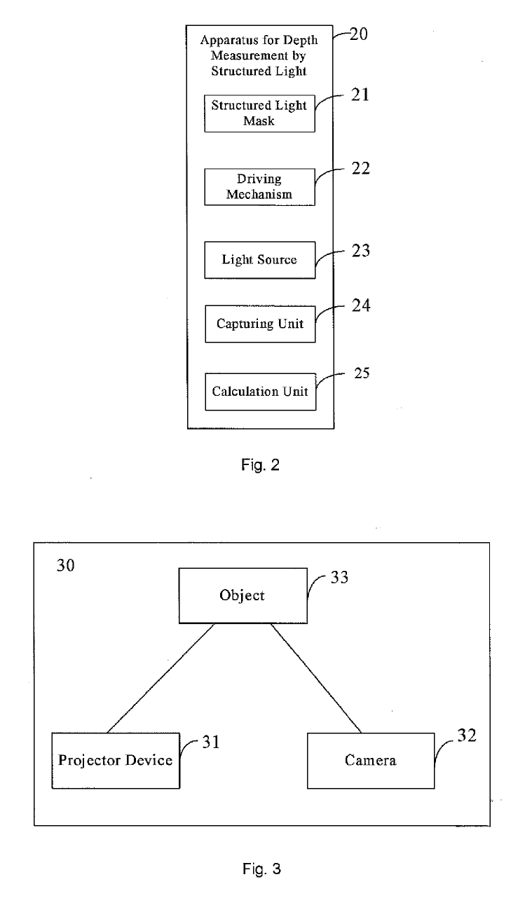

According to a further embodiment of the present disclosure, there is provided an apparatus of measuring a depth of an object by structured light. As shown in FIG. 2, the apparatus 20 may comprise a structured light mask 21, a driving mechanism 22, a light source 23, a capturing unit 24, and a calculation unit 25. The apparatus 20 can be configured to perform the method described above.

The structured light mask 21 is positioned in front of the light source 23. The structured light mask 21 can be configured to shield the light source 23 or can be provided with a number of slits, so that it can separate the light from the light source 23 into multiple projection light beams.

The driving mechanism 22 is configured to drive the structured light mask 21 to move within a prescribed range, and may comprise a motor, a magnetic material, or an ultrasonic-wave driving mechanism. The driving mechanism 22 may be connected to the structured light mask 21 in some cases, for example, if it is implemented by a motor, Alternatively, the driving mechanism 22 may be separate from the structured light mask 21 in other cases, for example, if it is implemented by a magnetic material or an ultrasonic-wave driving mechanism.

The light source 23 is configured to project structured light onto the object through the structured light mask 21. For example, the light source may comprise a light source for a projector, a laser light source, and the like. The present disclosure is not limited thereto.

The capturing unit 24 is configured to capture a first projection image from the structured light reflected by the object, and also a second projection image from further structured light which is caused by movement of the structured light mask 21 and then reflected by the object. For example, the capturing unit may comprise a video recorder, a camera, or other capturing devices. The present disclosure is not limited thereto.

According to an example of the present disclosure, driving of the structured light mask by the driving mechanism to move within the prescribed range and capturing of the projection images of the object by the capturing unit can be carried out synchronously. In this way, it is possible to avoid repeated capture of same projection images, and thus reduce unnecessary operations.

The calculation unit 25 is configured to derive a first depth value at a first positional point from the first projection image, derive a second depth value at a second positional point from the second projection image, and perform calculation on the first depth value and the second depth value to derive a resultant depth value.

FIG. 3 is a block diagram showing an exemplary system 30 for structured-light measurement according to an embodiment of the present disclosure. As shown in FIG. 3, the system 30 may comprise a projector device 31 and a camera 32. The projector device 31 can be configured to perform functionalities of the structured light mask 21, the light source 23, and the driving mechanism 22 as described above, and the camera 32 can be configured to perform functionalities of the capturing unit 24 as described above.

Here, the projector device 31 and the camera 32 may be positioned in a horizontal direction, and an object 33 may be positioned out of the plane on which the projector device 31 and the camera 32 are positioned.

With the apparatus according to the embodiment of the present disclosure, the first depth value is derived from the first projection image, and then a plurality of the second depth values can be derived from a plurality of the second projection images due to the movement of the structured light mask. The plurality of the second depth values and the first depth value can be processed in accordance with the predetermined rule to derive the resultant depth value. As a result, it is possible to enhance the measurement precision and also enable short distance use.

From the foregoing, it will be appreciated that specific embodiments of the disclosure have been described herein for purposes of illustration, but that various modifications or substitutions may be made without deviating from the disclosure. All the modifications and substitutions shall fall into the scope of the technology. Accordingly, the technology is not limited except as by the appended claims.

I/We claim:

1. A method of measuring a depth of an object by structured light, comprising:
projecting structured light from a light source to the object through a structured light mask;
capturing a first projection image from the structured light reflected by the object, and deriving a first depth value at a first positional point from the first projection image;
moving the structured light mask within a prescribed range to project further structured light to the object;
capturing a second projection image from the further structured light reflected by the object, and deriving a second depth value at a second positional point from the second projection image; and
repeatedly performing the operations of moving the structured light mask and deriving the second depth value to acquire a plurality of the second depth values, and performing calculation on the first depth value and the respective second depth values in accordance with a predetermined rule to derive a resultant depth value.

2. The method according to claim 1, wherein moving the structured light mask within the prescribed range comprises:
rotating the structured light mask at a preset time interval and at a preset angle clockwise or counterclockwise within the prescribed range.

3. The method according to claim 2, wherein moving the structured light mask within the prescribed range comprises:
driving the structured light mask by a motor, ultrasonic waves, or a magnetic material, to move within the prescribed range.

4. The method according to claim 3, wherein driving the structured light mask by the motor to move within the prescribed range comprises:
driving the structured light mask by the motor at a frequency to move within the prescribed range,
wherein the frequency at which the motor drives the structured light mask is substantially identical with a capturing frequency at which the second projection image is captured from the structured light reflected by the object.

5. An apparatus of measuring a depth of an object by structured light, comprising:
a structured light mask;
a driving mechanism configured to drive the structured light mask to move;
a light source configured to project structured light to the object through the structured light mask;
a capturing unit configured to capture a first projection image from the structured light reflected by the object, and capture a plurality of second projection images from further structured light which is caused by movements of the structured light mask and then reflected by the object; and
a calculation unit configured to derive a first depth value at a first positional point from the first projection image, derive second depth values at corresponding second positional points from the second projection images, and perform calculation on the first depth value and the respective second depth values to derive a resultant depth value.

6. The apparatus according to claim 5, wherein the driving mechanism comprises a motor, a magnetic material, or an ultrasonic-wave driving mechanism.
